(19) United States
(12) Patent Application Publication
(10) Pub. No.: US 2024/0204328 A1
(43) Pub. Date: Jun. 20, 2024

(54) BATTERY SYSTEM FOR HELMET MOUNT ASSEMBLY

(71) Applicant: WILCOX INDUSTRIES CORP., Newington, NH (US)

(72) Inventors: James W. Teetzel, Portsmouth, NH (US); Elliott S. Turner, Newmarket, NH (US)

(21) Appl. No.: 18/544,128

(22) Filed: Dec. 18, 2023

Related U.S. Application Data
(60) Provisional application No. 63/433,661, filed on Dec. 19, 2022.

(51) Int. Cl. H01M 50/244; A42B 3/04; F41H 1/04; H01M 50/247

(52) U.S. Cl. CPC H01M 50/244; A42B 3/0406; H01M 50/247; F41H 1/04; H01M 2220/30

(57) ABSTRACT

Battery pack system for helmet mount assembly comprises a center base module for electrical and physical attachment to a helmet mount. First and second battery packs configured for removable attachment to the center base module each have a pair of protruding attachment lugs. Each attachment lug has a first magnetic fastener element and a first electrical connector element. The center base module has a first and second side surfaces configured for detachably securing the first and second battery packs, respectively. Each of the first and second side surfaces comprise a pair of lug receptacles for receiving a respective one of the pairs of protruding attachment lugs. Each lug receptacle has a second magnetic fastener element for physically coupling to a respective one of the first magnetic fastener elements. Each lug receptacle has a second electrical connector element for electrically coupling to a respective one of the first electrical connector elements.

### CROSS REFERENCE TO RELATED APPLICATION

This application claims the priority benefit of U.S. provisional application No. 63/433,661 filed Dec. 19, 2022. The aforementioned application is incorporated herein by reference in its entirety.

### BACKGROUND

The present disclosure relates to batteries and, in particular, to a battery attachment system for a powered helmet mount assembly.

### SUMMARY

In one aspect, a battery pack system for a helmet mount assembly comprises a center base module configured for electrical and physical attachment to a helmet mount assembly. First and second battery packs are configured for removable attachment to the center base module. Each of the first and second battery packs have a pair of protruding attachment lugs, wherein each of the attachment lugs has first magnetic fastener element and a first electrical connector element. The center base module has a first side surface configured for detachably securing the first battery pack. The center base module has a second side surface opposite the first side surface configured for detachably securing the second battery pack. Each of the first and second side surfaces comprise a pair of lug receptacles for receiving a respective one of the pairs of protruding attachment lugs. Each lug receptacle has a second magnetic fastener element for physically coupling to a respective one of the first magnetic fastener elements. Each lug receptacle has a second electrical connector element for electrically coupling to a respective one of the first electrical connector elements.

In embodiments, the center base module includes a selector switch that allows switching between the left and right battery packs without interruption to the power being supplied to the helmet mount assembly, which allows rapidly switching of the power supply when one of the battery packs is depleted and avoids the need to shut down, reboot, or otherwise power cycle an attached accessory device receiving power over the helmet mount assembly.

The magnetic fastener elements also allow a depleted battery pack to be pulled away from the center base module by manually pulling the battery pack with a force greater than the magnetic force of attraction between the magnetic fastener elements, which allows the user to easily change the batteries with the battery pack in front of the body and in plain view of the user, which task would otherwise be difficult to do blindly reaching behind the back of the helmet.

In a further aspect, a battery pack system for a helmet mount assembly comprises a center base module configured for electrical and physical attachment to a helmet mount assembly. First and second battery packs are configured for removable attachment to the center base module. A first adapter is hingedly attached to a first side of the center base module and has a first interface surface configured for removable attachment to the first battery pack. A second adapter is hingedly attached to a second side of the center base module and has a second interface surface configured for removable attachment to the second battery pack.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of an exemplary embodiment powered helmet mounting assembly attached to a helmet taken generally from the rear and left side, the powered helmet mounting assembly having a first embodiment battery pack center base module attached to a rear mount assembly of the powered helmet mounting assembly.

FIG. 2 is a top plan view of the helmet with the powered helmet mounting assembly and battery pack center base module appearing in FIG. 1,

FIG. 3 is an enlarged, top plan view of the battery pack center base module appearing in FIG. 1.

FIG. 4 is an enlarged, rear elevational view of the battery pack center base module appearing in FIG. 3.

FIG. 5 is an isometric view, taken generally from the rear and left side, of the exemplary embodiment powered helmet mounting assembly, helmet, and battery pack center base module appearing in FIG. 1, showing the battery pack center base module shown detached from the rear mount assembly of the powered helmet mounting assembly and further showing the manner in which the battery pack center base module can be replaced with a battery pack adapter to allow other battery packs, such as legacy battery packs, to be operably coupled to the helmet mounting system.

FIG. 6 is an isometric view of the powered helmet mounting assembly, helmet, and battery pack center base module appearing in FIG. 1, wherein left and right battery packs as removably attached to the battery pack center base module.

FIG. 7 is a top plan view of the powered helmet mounting assembly, helmet, battery pack center base module, and left and right battery packs appearing in FIG. 6.

FIG. 8 is a top plan view of the battery pack center base module with left and right battery packs appearing in FIG. 6.

FIG. 9 is a rear elevational view of the battery pack center base module with left and right battery packs appearing in FIG. 6.

FIG. 10 is a front elevational view of the battery pack center base module with left and right battery packs appearing in FIG. 6.

FIG. 11 is a fragmentary top view of the helmet with powered helmet mounting assembly, with the battery pack center base module attached to the rear mount assembly on the powered helmet mounting assembly.

FIG. 12 is an exploded top plan view of the battery pack center base module with left and right battery packs appearing in FIG. 8.

FIG. 13 is an enlarged isometric view of showing the manner of attachment of a battery pack to battery pack center base module.

FIG. 14 is an enlarged elevational view of the battery pack center base module showing the left side battery pack connector interface.

FIG. 15 is an enlarged end elevational view of a battery pack, taken from the connection interface end.

FIG. 16 an enlarged elevational view of the battery pack appearing in FIG. 15, taken generally from the side.

FIG. 17 an elevational view of a battery pack attached to the right side of the battery pack center base module, with a cutaway region showing the electrical and physical connections.

FIGS. 18 and 19 illustrate the battery pack center base module with an alternative battery pack and show the manner of attaching the battery pack to the battery pack center base module.

FIG. 20 illustrates the battery pack center base module with another alternative battery pack.

FIG. 21 illustrates the battery pack center base module with yet another alternative battery pack.

FIG. 22 is an isometric view of the battery pack center base module with left and right battery packs attached and showing the hinged rear panel in the open position for receiving a modular processing board cartridge.

FIG. 23 is an enlarged rear elevational view of the modular processing board cartridge appearing in FIG. 22.

FIG. 24 is an enlarged bottom plan view of the modular processing board cartridge appearing in FIG. 23.

FIG. 25 is an isometric view of the battery pack center base module with left and right battery packs attached and showing the hinged bottom panel in the open position for receiving programmable electronic storage media, such as non-volatile flash memory cards.

FIG. 26 is an isometric view of a further exemplary embodiment powered helmet mounting assembly attached to a helmet taken generally from the rear and left side, the powered helmet mounting assembly having the first embodiment battery pack center base module attached to a rear mount assembly of the powered helmet mounting assembly, the battery pack center base module further including left and right battery pack adapters for removably attaching battery packs in accordance with the Small Tactical Universal Battery (STUB) standard (e.g., Department of Defense MIL-PRF-32383).

FIG. 27 is a rear elevational view of the battery pack center base module and two attached STUB battery packs.

FIG. 28 is a partially exploded view of the battery pack center base module and STUB battery packs appearing in FIG. 27.

FIG. 29 is fragmentary isometric view of an exemplary STUB battery pack useable with the present development.

FIG. 30 is aside elevational view of the STUB battery pack adapter.

FIG. 31 is a first end elevational view of the STUB battery pack adapter illustrating the connection interface for attaching the STUB battery pack.

FIG. 32 is a second end elevational view of the STUB battery pack adapter illustrating the connection interface for attaching the STUB battery pack adapter to the battery pack center base module.

FIG. 33 illustrates a second embodiment battery pack center base module with a hinged interface configured for removably attaching STUB battery packs.

FIG. 34 is a top plan view of the battery pack center base module with left and right attached STUB battery packs, showing the range of pivoting hinge movement allowing the STUB battery packs to be pivoted in relation to the battery pack center base module toward and away from the helmet.

FIG. 35 is an isometric view of the battery pack center base module with left and right STUB battery packs, illustrating the manner of attaching and detaching the STUB battery packs.

FIG. 36 is an elevational view of the hinged connector on the battery pack center base module, illustrating the connection interface of the hinged connector.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

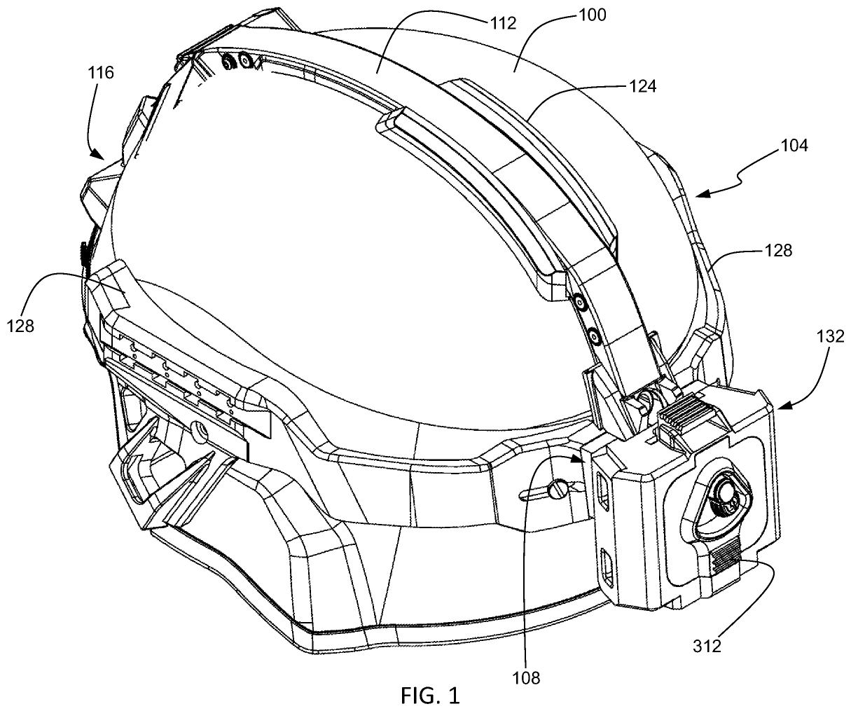

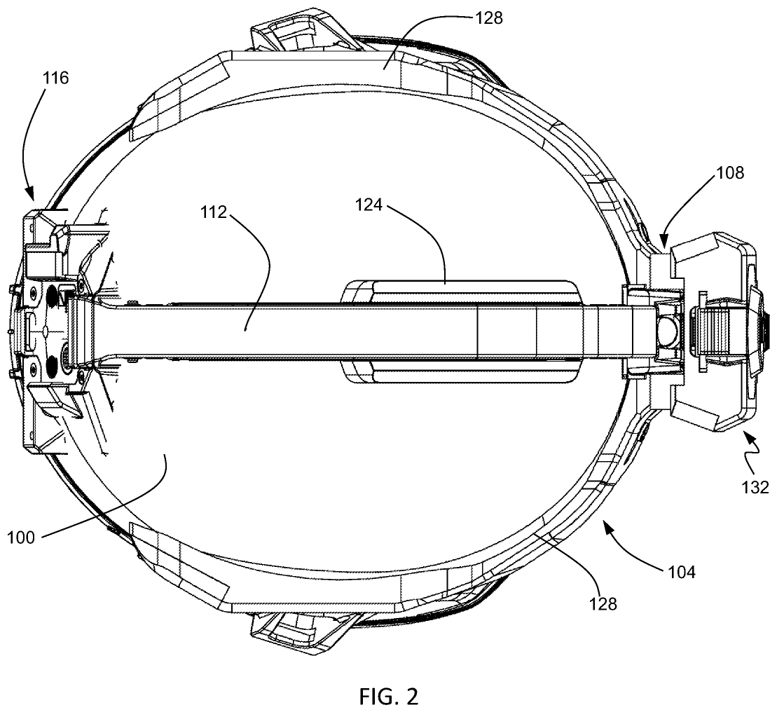

Referring now to FIGS. 1 and 2, there is shown a helmet 100 having a helmet mount assembly designated generally as reference numeral 104. In embodiments, the helmet mount assembly may be as shown and described in commonly owned U.S. provisional patent application Ser. No. 63/427,496 filed Nov. 23, 2022, the entire contents of which are incorporated herein by reference in its entirety. In the illustrated embodiment, the helmet 100 is an Integrated Head Protection System (IHPS) helmet, it will be recognized that the present development can be adapted for use with all manner of protective helmets, including a Modular Integrated Communications Helmet (MICH), Advanced Combat Helmet (ACH), Enhanced Combat Helmet (ECH), and so forth.

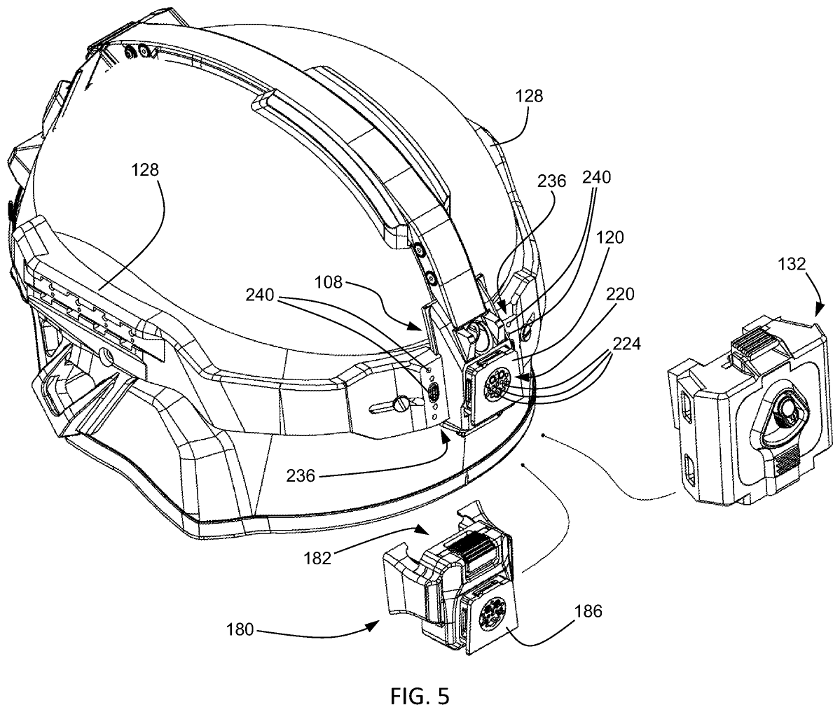

In the illustrated embodiment, the helmet mount assembly 104 includes a rear battery mounting bracket 108 disposed at the rear of the helmet 100. A strap or cable cover 112 extends along a centerline of the helmet 100 from the rear battery mounting bracket 108 to a front shroud 116 disposed at the front of the helmet 100. The battery mounting bracket 108 includes a hot shoe style interface 120 (see FIG. 5). The front shroud 116, strap or cable cover 112, and rear mounting bracket 108 may be as described in commonly-owned U.S. Pat. No. 10,886,646 or commonly-owned U.S. Pat. No. 11,360,309, each of which is incorporated herein by reference in its entirety. An identification friend or for (IFF) module 124 is retained on the helmet 100 via the strap/cable cover 112. Left and right shrouds 128 are attached to the respective left and right sides of the helmet 100 via a threaded fastener 134 engaging a clearance opening 136 in the shrouds 132 and extend between the rear battery mounting bracket 108 and the front shroud 116. A battery pack center base module 132 is releasably attached to the rear battery mounting bracket 108

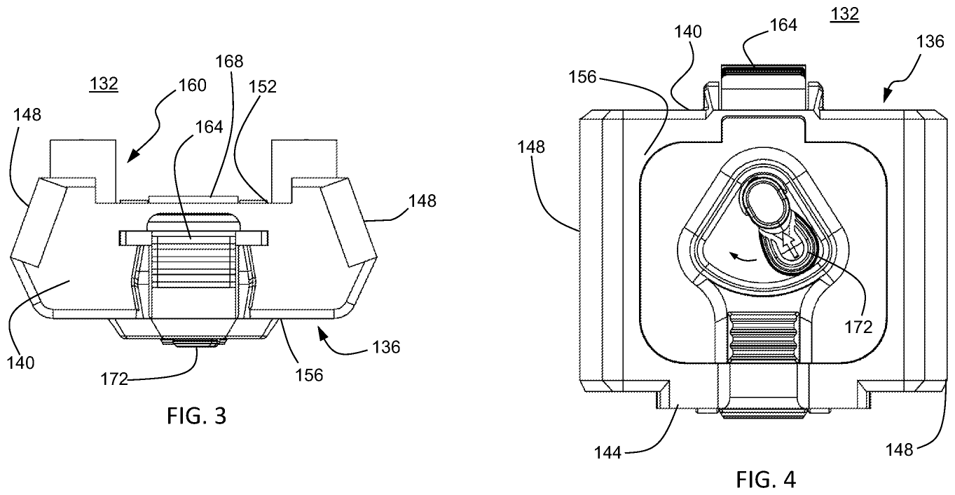

Referring now to FIGS. 3 and 4, and with continued reference to FIGS. 1 and 2, the battery pack center base module 132 includes a main body 136 having a top surface 140, bottom surface 144, left and right side surfaces 148, a front or forward facing surface 152, and a rear or rearward facing surface 156. The front facing surface 152 includes a hot shoe receptacle 160 for detachably receiving the hot shoe mounting interface 120 on the rear battery mounting bracket 108. As best seen in FIG. 5, in the illustrated embodiment, the hot shoe interface 120 includes a dovetail mounting member and the hot shoe receptacle 160 includes a complementary dovetail receptacle for sliding engagement. A latch release button 164 is disposed on the upper surface 140 for disengaging a latch member 168 to allow sliding removal of the battery pack center base module 132 from the rear battery mounting bracket 108.

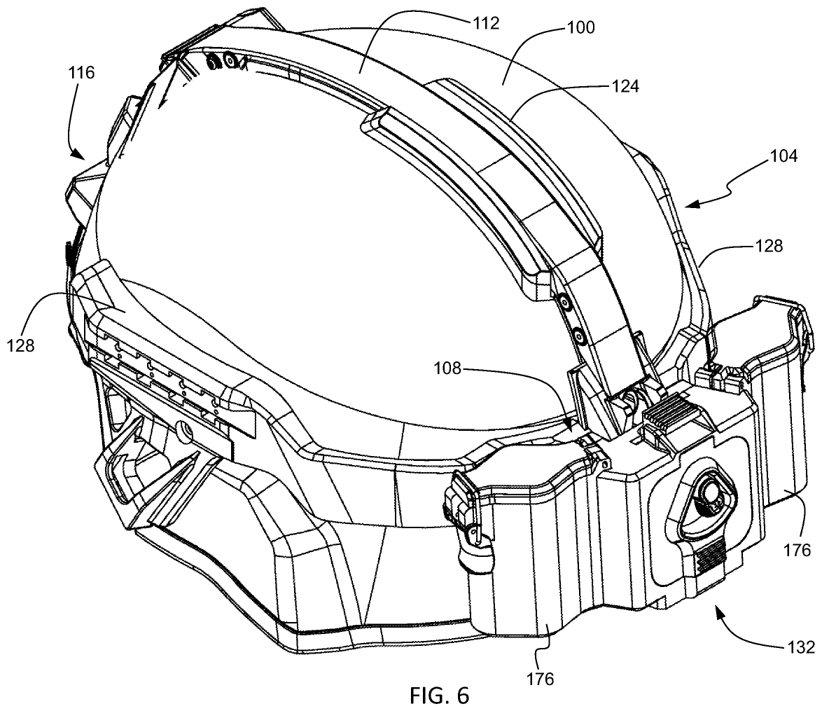

A battery selector switch 172 is pivotable between a left position and a right position. When the selector switch 172 is in the right position, the battery pack center base module 132 electrically couples a battery pack 176 (see FIG. 6) attached to the right side of the battery pack center base module 132 to the helmet mount assembly 104 via the rear battery mounting bracket 108. When the selector switch 172 is moved the left position as indicated by the arrow appearing in FIG. 4, the battery pack center base module 132 electrically couples a battery pack 176 (see FIG. 6) attached to the right side of the battery pack center base module 132 to the helmet mount assembly 104 via the rear battery mounting bracket 108. In operation, the user may use one of the battery packs 176 until it is depleted or nearly depleted and then use the selector switch 172 to switch the electrical connection to the other one of the battery packs 176.

In embodiments, the selector 172 allows switching between the left and right battery packs without interruption to the power being supplied to the helmet mount assembly 104. This is particularly advantageous when an accessory device attached to the helmet mount assembly 104 is a night vision device or other device which requires rebooting, which can sometimes take several minutes to complete, when the power is cycled. Each battery pack 176 is individually swappable such that when one battery pack 176 is depleted it can be changed without affecting operation of the devices being powered. In operation, when one of the battery packs 176 is depleted, the user then moves the selector switch to the battery pack 176 that is fully charged. The depleted battery pack 176 can then be pulled away from the center base module 132, overcoming the force of attraction between the magnetic fastener elements on the center base module and the battery pack, thereby allowing the user to easily change the batteries in front of the body in plain view of the user; whereas, otherwise this task is difficult to do blindly reaching around the back.

Referring now to FIG. 5 and with continued reference to FIGS. 1-4, there is shown a helmet 100 with helmet mount assembly 104 with the rear battery mounting bracket 108 configured to receive the battery pack center base module 132, wherein the helmet mounting system further includes a battery pack adapter 180 configured to interchangeably attach to the rear battery mounting bracket 108 in place of the battery pack center base module 132. The adapter 180 includes a receptacle 182 receiving the hot shoe 120 and a hot shoe 186 configured to attach an existing or legacy battery pack (not shown). The dedicated battery pack center base module 132 is advantageous in that it does not require an adapter and connects directly to the helmet mount assembly 104 and thereby reduces the profile of the attached battery pack in relation to the surface of the helmet. However, the battery pack adapter 180 increases the functionality of the helmet mount assembly 104 in that allows for the use of other types of battery packs, such as preexisting or legacy battery packs, such as Elbit battery packs (e.g., ENVG-B battery box), Harris L3 battery packs, and the like.

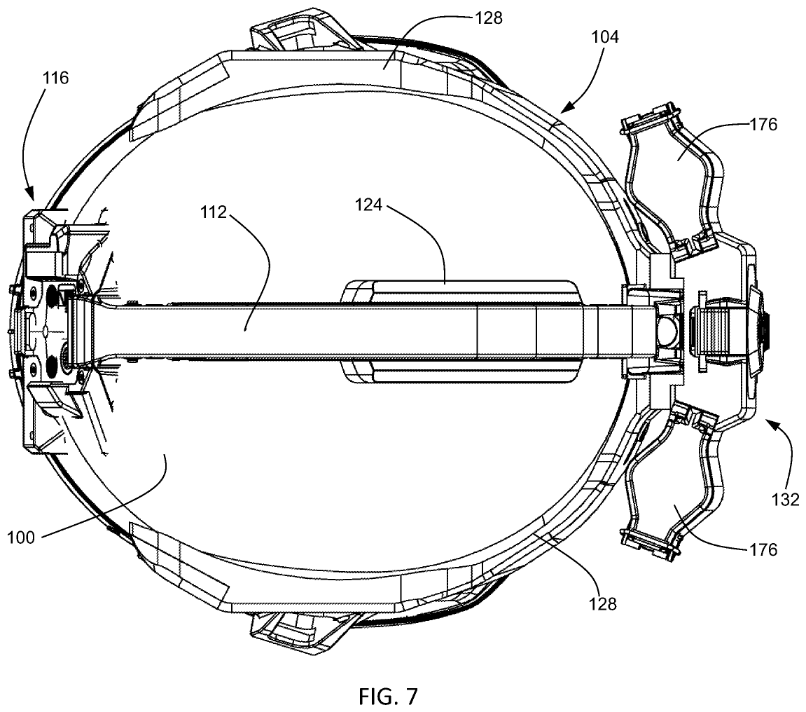

Referring now to FIGS. 6 and 7 and with continued reference to FIGS. 1-5, there is shown a helmet 100 with helmet mount assembly 104 with the rear battery mounting bracket 108 receiving the battery pack center base module 132, as shown in FIGS. 1 and 2, respectively, wherein the battery pack center base module 132 has a battery pack 176 attached to each of the left and right side surfaces 148 thereof.

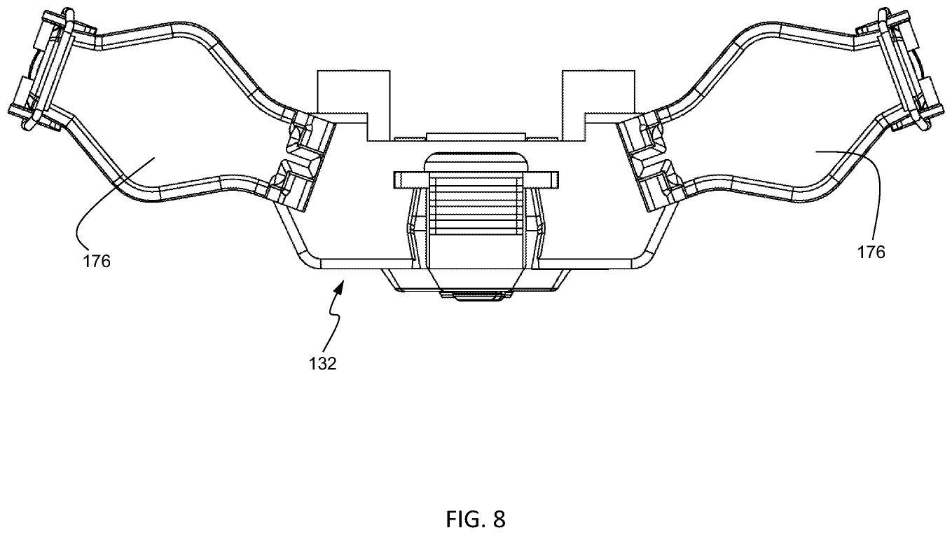

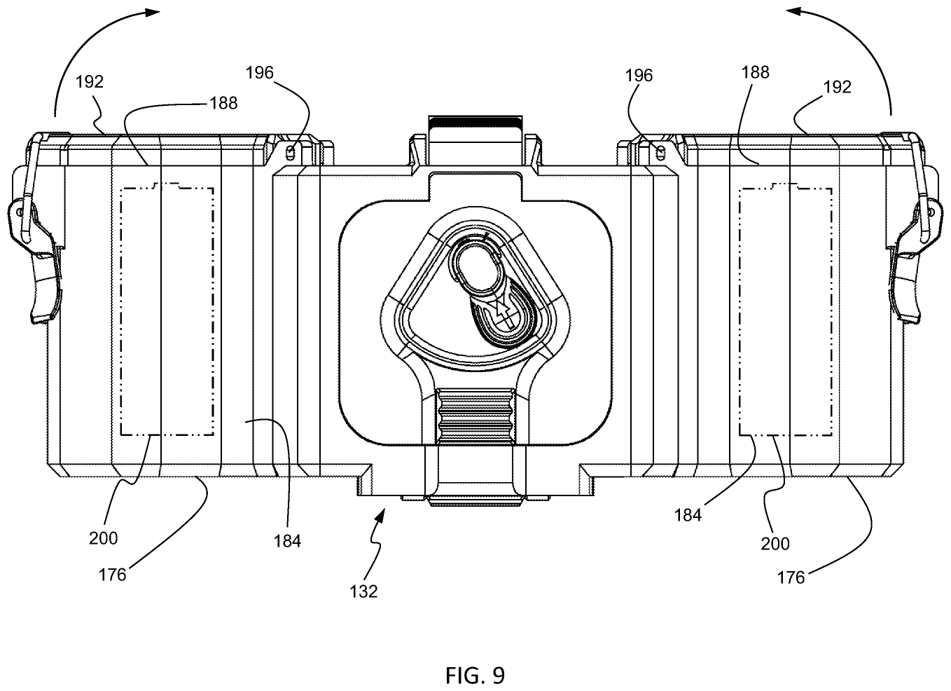

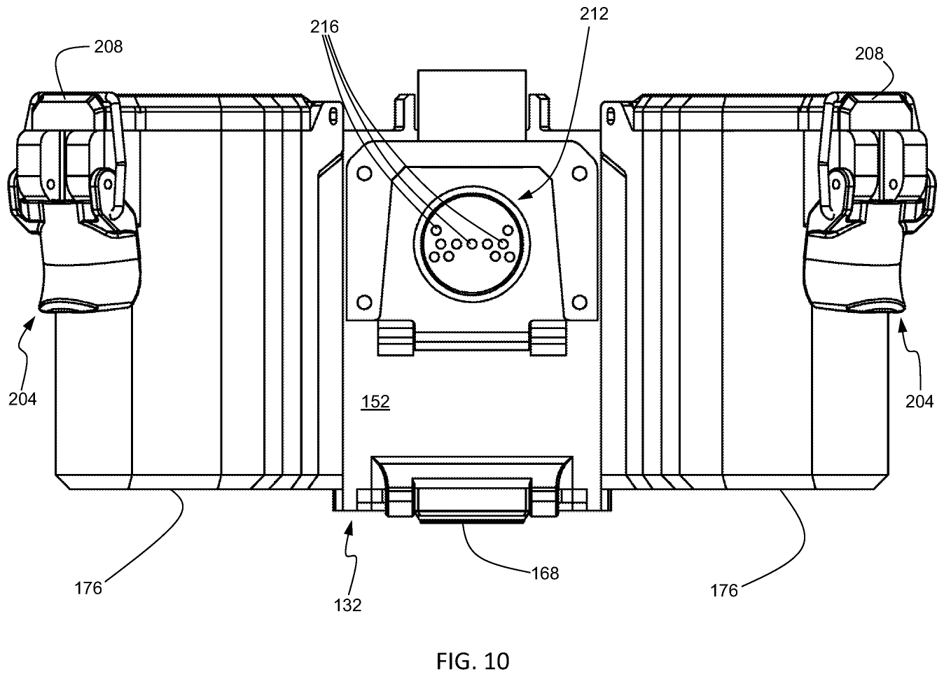

Referring now to FIGS. 8-10 and with continued reference to FIGS. 1-7, there is shown top, rear, and front views, respectively, of the battery pack center base module 132, as shown in FIGS. 3 and 4, respectively, wherein the battery pack center base module 132 has a battery pack 176 attached to each of the left and right side surfaces 148 thereof.

In the illustrated exemplary embodiment, the battery pack 176 includes a housing 184 defining a battery compartment. The housing 184 has an open upper end 188 which is closed by a hinged cover 192. The hinged cover 192 is pivotally attached to the housing 184 via a hinge 196 disposed at the proximal end of the cover 192 to allow opening and closing of the battery pack for insertion and removal of battery(ies) 200 into and from the housing 184. In embodiments, housing 184 includes releasable coupling element 204, secured to the housing 184 adjacent the distal end of the battery pack cover 192, such as a latch (e.g., draw latch), clasp, buckle, or other releasable coupling as would be understood by persons skilled in the art. The coupling element 204 releasably engages a complementary attachment feature, such as a catch 208 disposed on the distal end of the cover 192.

The forward facing surface 152 of the battery pack center base module 132 includes an electrical connector element 212 comprising a plurality of electrical contacts 216. The connector element 212 is aligned with an opposing connector element 220 on the hot shoe interface 120 on the rear battery mounting bracket 108, the connector element 220 comprising a plurality of electrical contacts 224 which are aligned with and face the electrical contacts 216 to provide communication of power, data, and control signals between the battery pack center base module 132 and the helmet mount assembly 104.

The forward facing surface 152 of the battery pack center base module 132 further includes an electrical connector element 212 comprising a plurality of electrical contacts 216. The connector element 212 is aligned with an opposing connector element 220 on the hot shoe interface 120 on the rear battery mounting bracket 108, the connector element 220 comprising a plurality of electrical contacts 224 which are aligned with and face the electrical contacts 216.

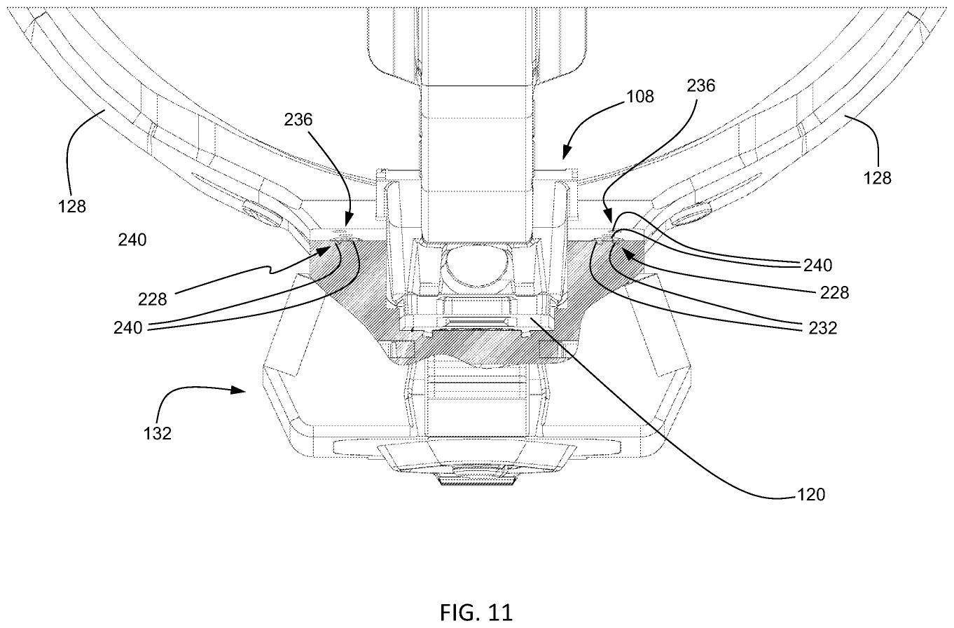

Referring now to FIG. 11, and with continued reference to FIGS. 1-10, there is shown a top view illustrating the battery pack center base module 132 attached to the rear battery mounting bracket 108, wherein a portion of the battery pack center base module 132 is cutaway to show the hot shoe 120 within the hot shoe receptacle 160. The forward facing surface 152 of the battery pack center base module 132 further includes a left and right electrical connector elements 228 comprising a plurality of electrical contacts 232. The connector elements 228 are aligned with opposing left and right connector elements 236 on the left and right helmet brackets 128, respectively. The connector element 236 comprises a plurality of electrical contacts 224 which are aligned with and face the electrical contacts 232.

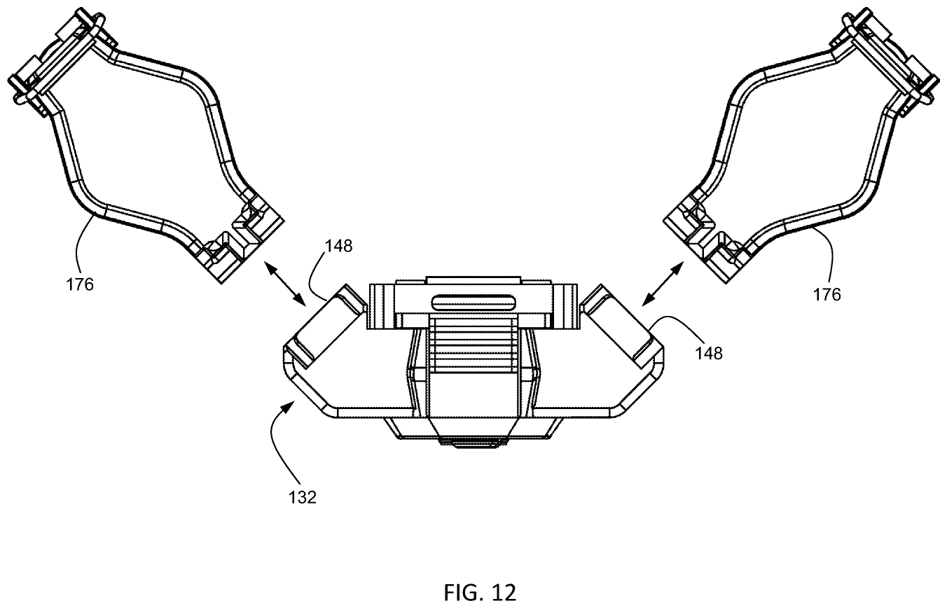

Referring now to FIG. 12, and with continued reference to FIGS. 1-11, there is shown the battery pack center base module 132 with the left and right battery packs 176 spaced apart from the respective left and right side surfaces 148, illustrating the manner of attachment and removal of the battery packs 176 from the battery pack center base module 132.

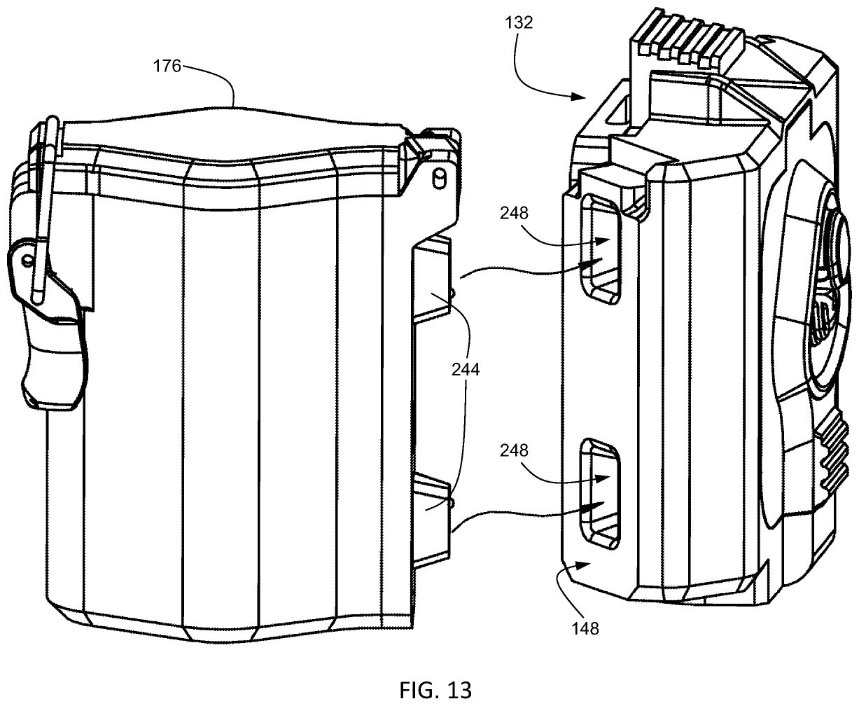

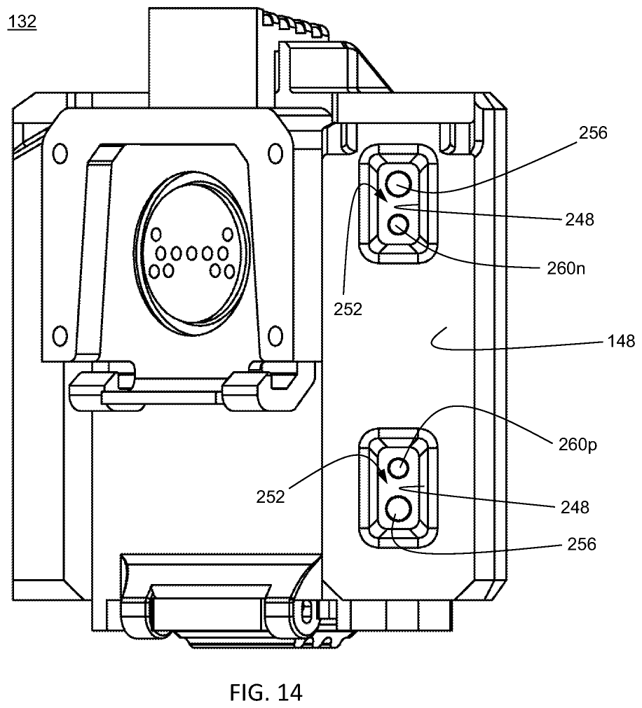

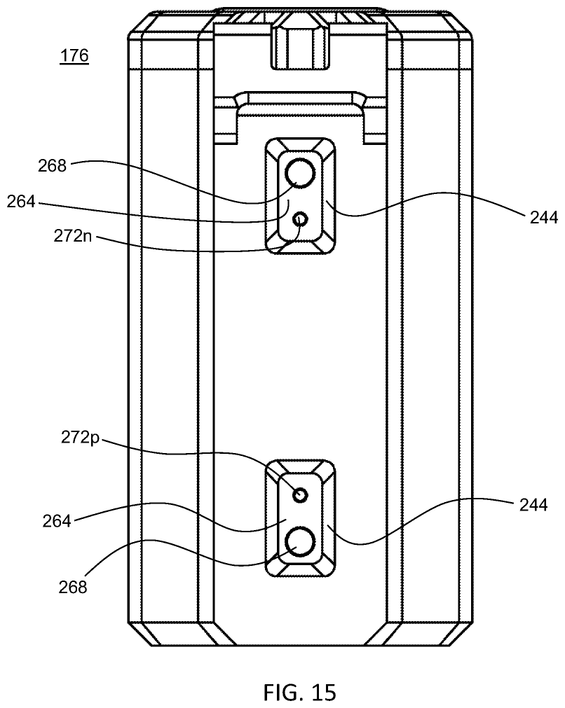

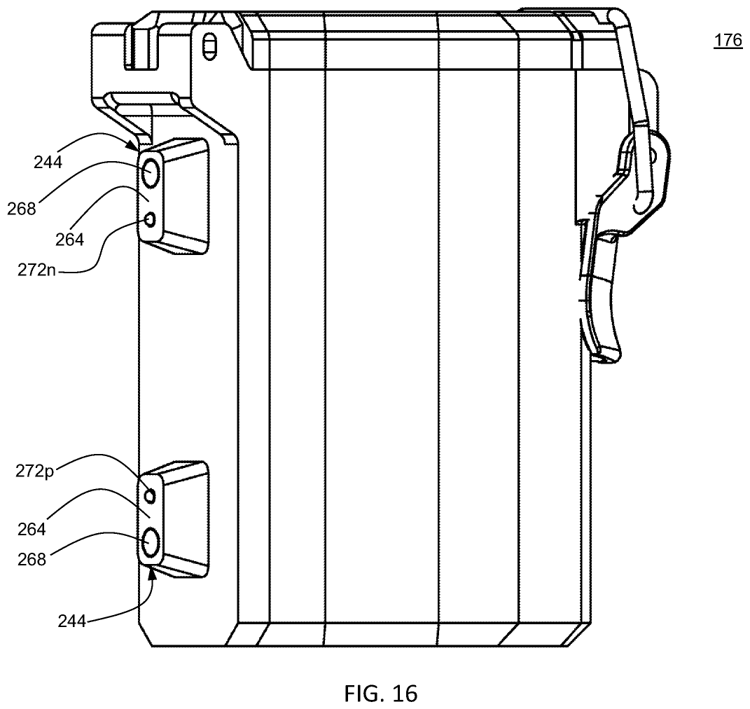

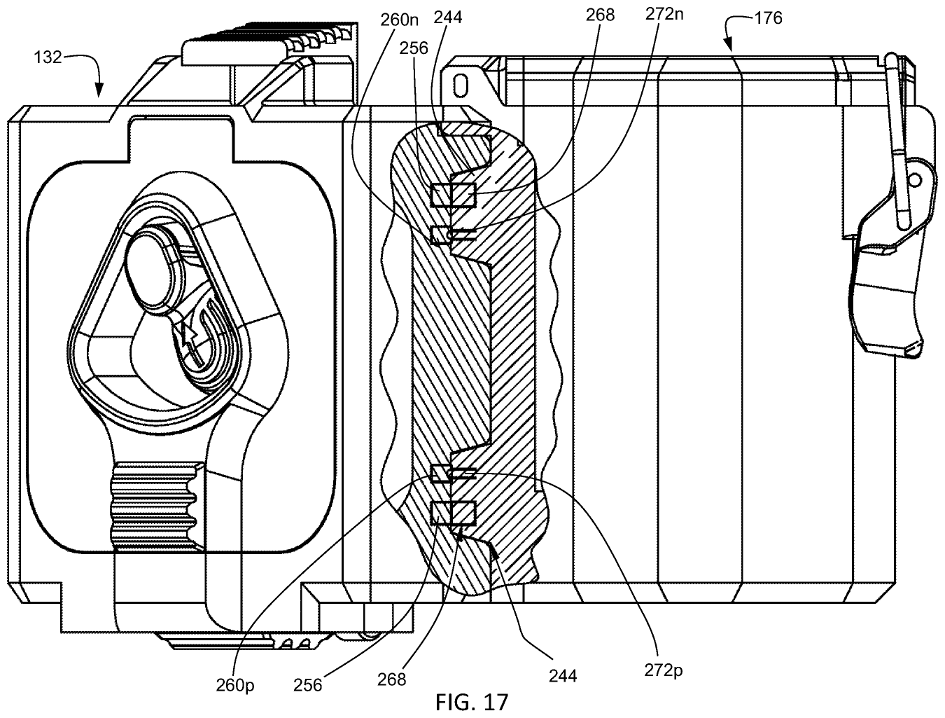

Referring now to FIGS. 13-17, and with continued reference to FIGS. 1-12, there is illustrated the manner of attachment of the battery packs 176 to the battery pack center base module 132. The battery pack housing 184 includes a pair of frusto-pyramidical lugs 244 which releasably seat in correspondingly shaped receptacles or sockets 248 formed in the side surface 148 of the battery pack center base module 132. It will be recognized that the lugs 244 may have other geometrical configurations, such as frusto-conical, truncated triangular pyramid, and so forth. A base surface 252 of each receptacle 252 includes a magnetic fastener element 256 and an electrical contact 260p, 260n. An upper surface 264 of each lug 244 includes a magnetic fastener element 268 is aligned with the magnetic fastener element 256 and an electrical contact 272p, 272n which is aligned with a respective one of the electrical contacts 260p, 260n. In embodiments, the electrical contact 272n is electrically coupled to the negative terminal of the battery(ies) 200 in the battery pack 176 and the electrical contact 272p is electrically coupled to the positive terminal of the battery(ies) 200 in the battery pack 176.

In certain embodiments, the magnetic fastener elements 256 and 268 are each permanent magnets wherein the aligned faces are of opposite polarity to provide a physical connection between the battery pack center base module 132 and the battery pack 176 when the lugs 244 are inserted into the sockets 248. In alternative embodiments, for each of the magnetic fastener element pairs 256, 268, one is a permanent magnet and the other is formed of a magnetically attractable material such as a ferromagnetic metal to provide a physical connection between the battery pack center base module 132 and the battery pack 176. In operation, to remove the battery pack 176 from the battery pack center base module 132 to user exerts a pulling force on the battery pack 176 which is greater than the magnetic force of attraction between the fastener elements 256, 268.

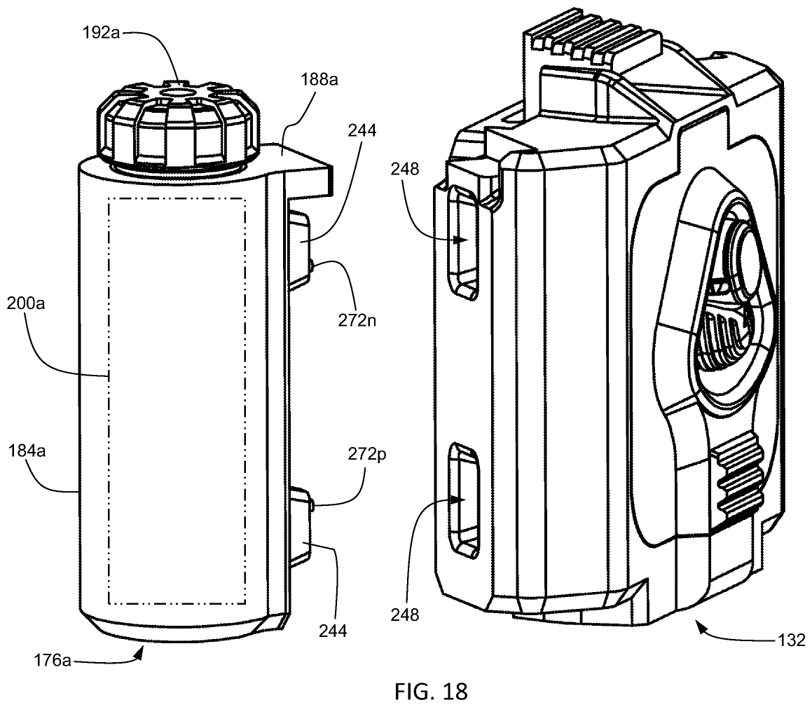

Referring now to FIG. 18, and with continued reference to FIGS. 1-17, there appears the battery pack center base module 132 and a first alternative embodiment battery pack 176a. In the illustrated exemplary embodiment, the battery pack 176a includes a housing 184a defining a battery compartment configured to receive a single AAA battery 200a. The housing 184a has an open upper end 188a which is closed by a removable threaded cap 192a.

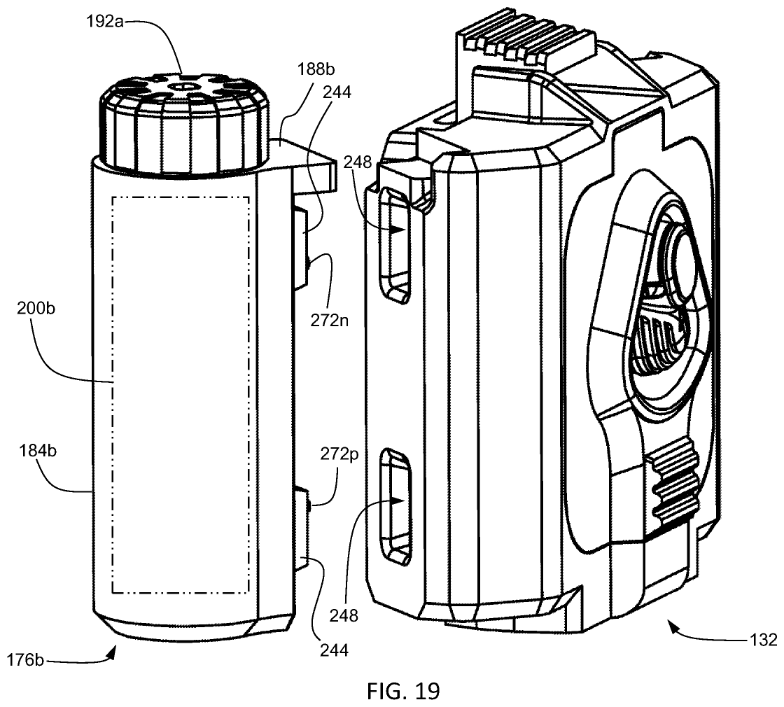

Referring now to FIG. 19, and with continued reference to FIGS. 1-18, there appears the battery pack center base module 132 and a second alternative embodiment battery pack 176b. In the illustrated exemplary embodiment, the battery pack 176b includes a housing 184b defining a battery compartment configured to receive a single CR123A battery 200b. The housing 184b has an open upper end 188b which is closed by a removable threaded cap 192a.

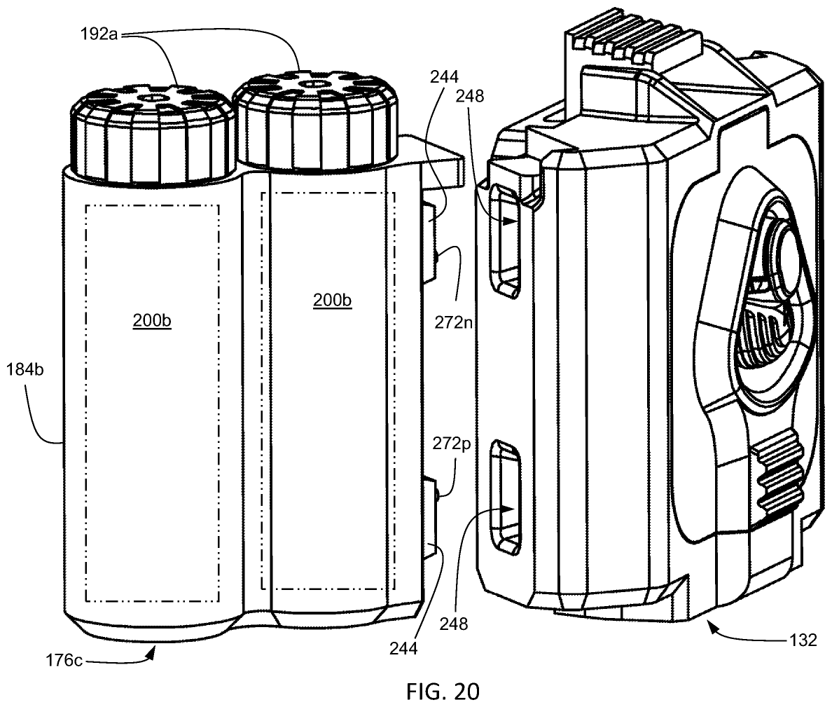

Referring now to FIG. 20, and with continued reference to FIGS. 1-19, there appears the battery pack center base module 132 and a third alternative embodiment battery pack 176c. In the illustrated exemplary embodiment, the battery pack 176c includes a housing 184c defining two battery compartments each configured to receive a CR123A battery 200b. The battery compartments have an open upper ends which are closed by removable threaded caps 192a.

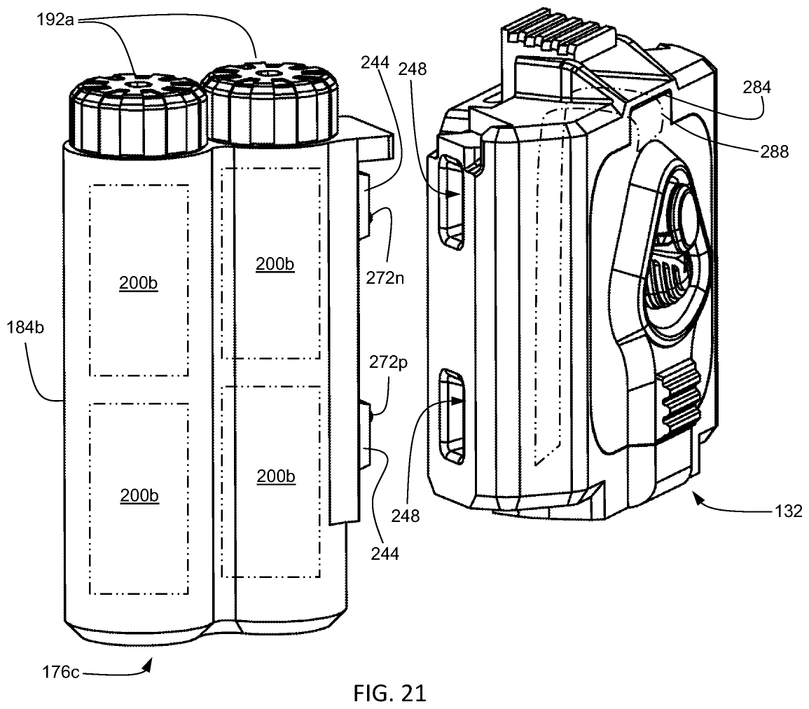

Referring now to FIG. 21, and with continued reference to FIGS. 1-20, there appears the battery pack center base module 132 and a fourth alternative embodiment battery pack 176d. In the illustrated exemplary embodiment, the battery pack 176d includes a housing 184d defining two battery compartments each configured to receive two CR123A batteries 200b. The battery compartments have an open upper ends which are closed by removable threaded caps 192a.

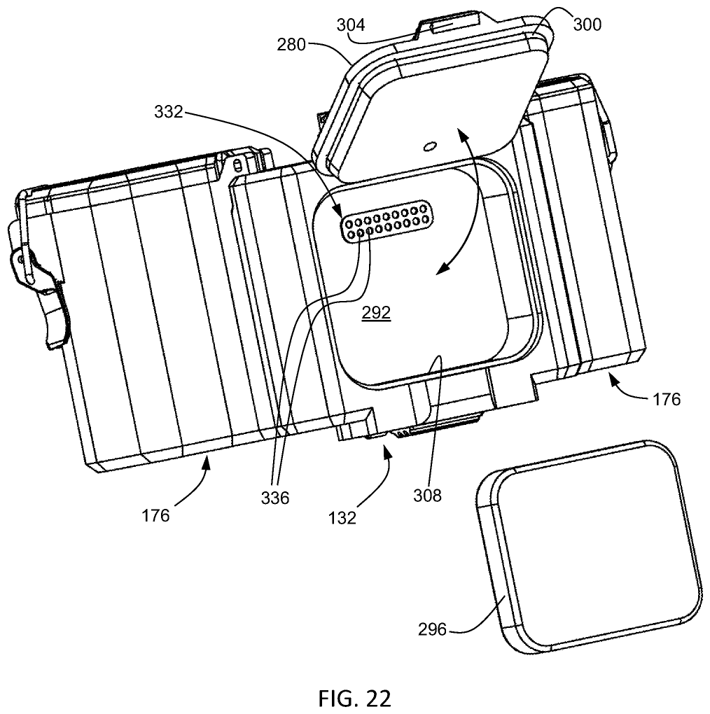

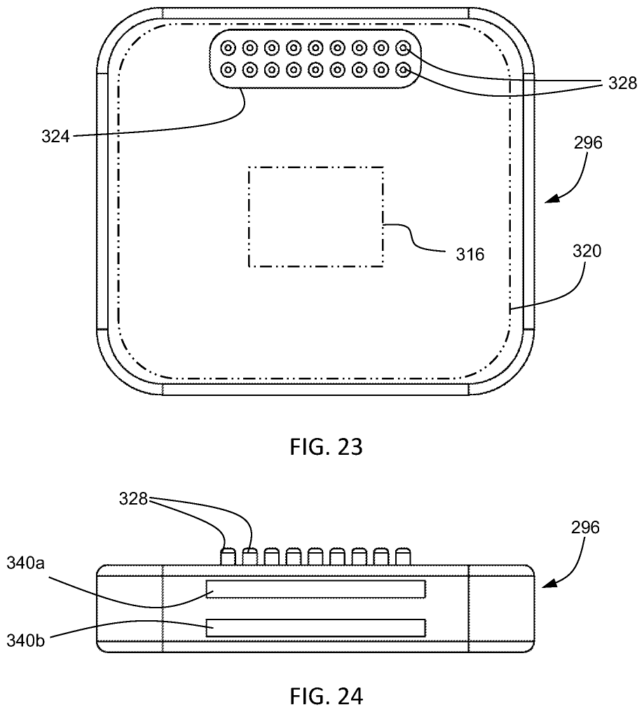

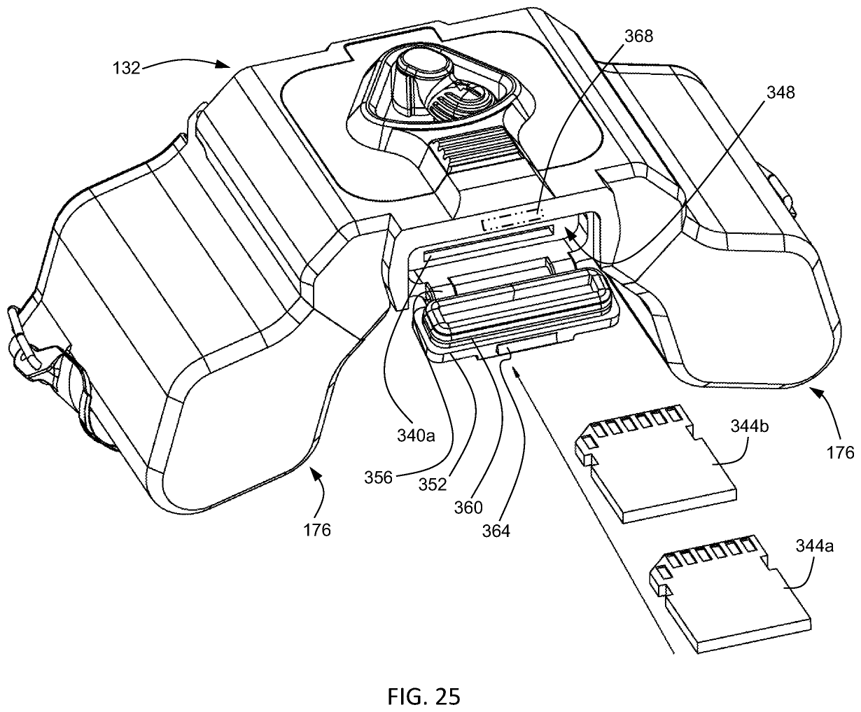

Referring now to FIGS. 22-25, and with continued reference to FIGS. 1-21, the battery pack center base module 132 includes a hatch door 280 on the rear surface 156 of the main body 136 which covers a cavity 292 configured to receive a modular processing board cartridge 296. The door 280 is pivotable about a hinge 284. The battery pack selector switch 172 is electrically coupled to the electrical components within the main body 136 via a flex circuit 288 which passes through the hinge 284 and which comprises circuit conductors or traces formed on a flexible substrate such as a flexible tape or film material, which may be formed, e.g., of a polymeric material. An elastomeric O-ring or gasket 300 is provided to seal against entry or moisture or other contamination into the cavity 292. The door 280 is retained in the closed position via a latch member 304 releasably engaging a catch 308 on the main body 136 housing. The door 280 is opened by manually disengaging the latch member 304 from the catch using a latch release 312 disposed on the door 280.

The modular processing board cartridge 296 includes a main board 316 including a processor 320, such as microprocessor, central processing unit, microcontroller, or the like, including an associated memory and processing electronics. A connector interface 324 includes a plurality of electrical contacts 328 which engage aligned electrical contacts 336 on a mating connector 332 disposed in the cavity 292. In embodiments, the contacts 328 are spring loaded pogo pins of the type comprising a barrel, plunger and encapsulated spring and the contacts 336 are complementary contact pads. The modular processing board cartridge 296 allows the processing capability of the battery pack center base module 132 to be swapped and updated. In certain embodiments, the cartridge dimensions and pin locations are controlled with an interface control document (ICD) to provide an open architecture allowing other manufacturers to make their own customized processing units tailored for specific electrical and processing requirements. In such embodiments, the center base module 132 is an “open architecture” platform allowing other manufactures to install their own unique electronic circuitry in the cavity 292.

The modular processing board cartridge 296 includes first and second card slots 340a and 340b for receiving first and second nonvolatile memory cards 344a and 344b, respectively, such as flash memory cards, Secure Digital (SD) cards, or the like. The modular processing board cartridge 296 is inserted and removed via the hatch door 280. In certain embodiments, one of the card slots 340a, 340b is used for expandable storage, to upload mission profiles, and/or for software/firmware upgrades, and the other one of the card slots 340a, 340b is used for programming logic and the operating system.

The first and second nonvolatile memory cards 344a and 344b are inserted and removed from the first and second card slots 340a and 340b through an opening 348 in the bottom surface 144 of the battery pack center base module 132. The opening 348 is covered by a bottom door 352 which is attached to the main body 136 via a hinge 356. An elastomeric O-ring or gasket 360 provides a sealing interference between the door 352 and the main body 136 to prevent entry of moisture or other contamination into the cavity 292 or cartridge 296. A releasable latch 364 on the bottom door 352 engages a catch 368 on the main body 136.

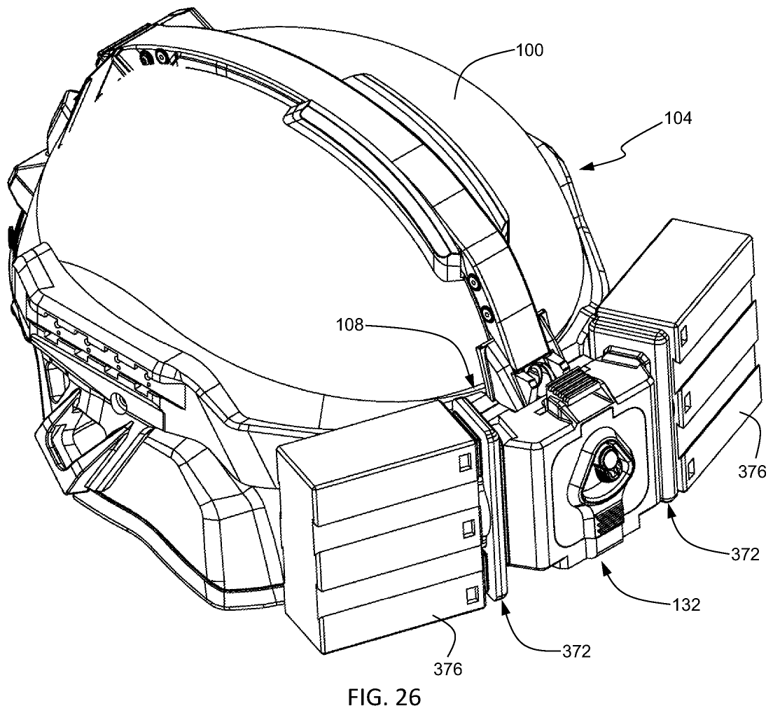

Referring now to FIG. 26 and with continued reference to FIGS. 1-25, there is shown a helmet 100 with helmet mount assembly 104 with the rear battery mounting bracket 108 receiving the battery pack center base module 132, as shown in FIG. 1, wherein the battery pack center base module 132 has left and right Small Tactical Universal Battery (STUB) battery packs 376 attached to each of the left and right side surfaces 148 of the battery pack center base module 132 via STUB adapters 372.

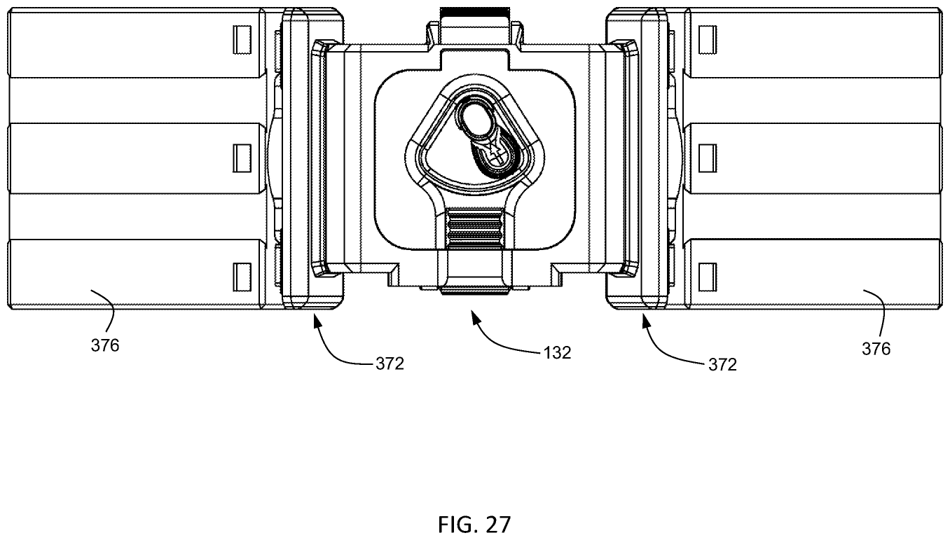

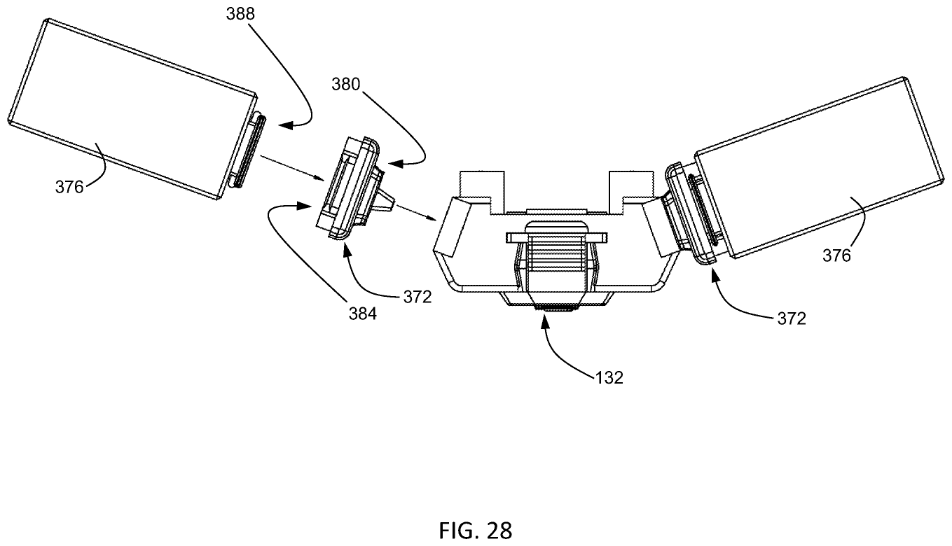

Referring now to FIGS. 27 and 28, and with continued reference to FIGS. 1-26, each STUB adapter 372 has a first interface surface 380 configured to detachably engage with the side surfaces 148 on the battery pack center base module 132 and a second interface surface 384 opposite the first interface surface 380 configured to detachably engage with a standard STUB battery pack interface 388.

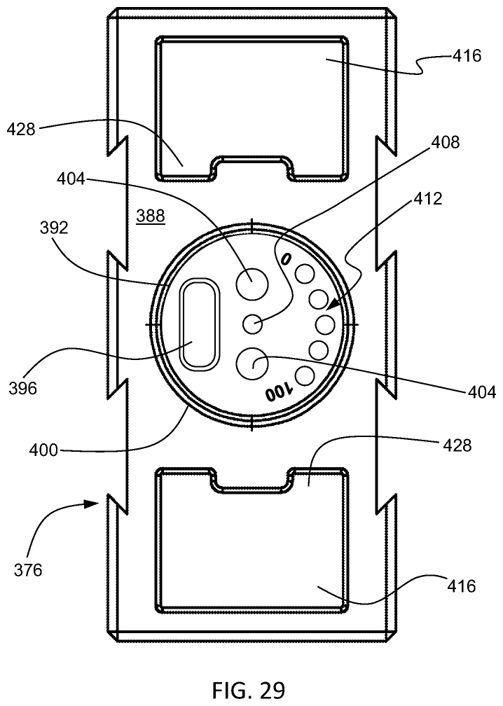

Referring now to FIG. 29, and with continued reference to FIGS. 1-28, there is shown an exemplary STUB battery pack 376 which comprises an interface surface 388. In the illustrated embodiment, the STUB interface surface 388 includes a center terminal 392. The center terminal includes an elastomeric sealing ring 396 for sealing between the terminal 392 and the housing of the battery pack 376. The terminal 392 includes a USB-C charging port 400, power terminals 404 404, a control signal terminal 408, and state of charge indicia 412. In certain embodiments, the STUB battery pack 376 may be generally as described in U.S. Patent Application Publication No. 2022/0216554 published on Jul. 7, 2022, which is incorporated herein by reference in its entirety.

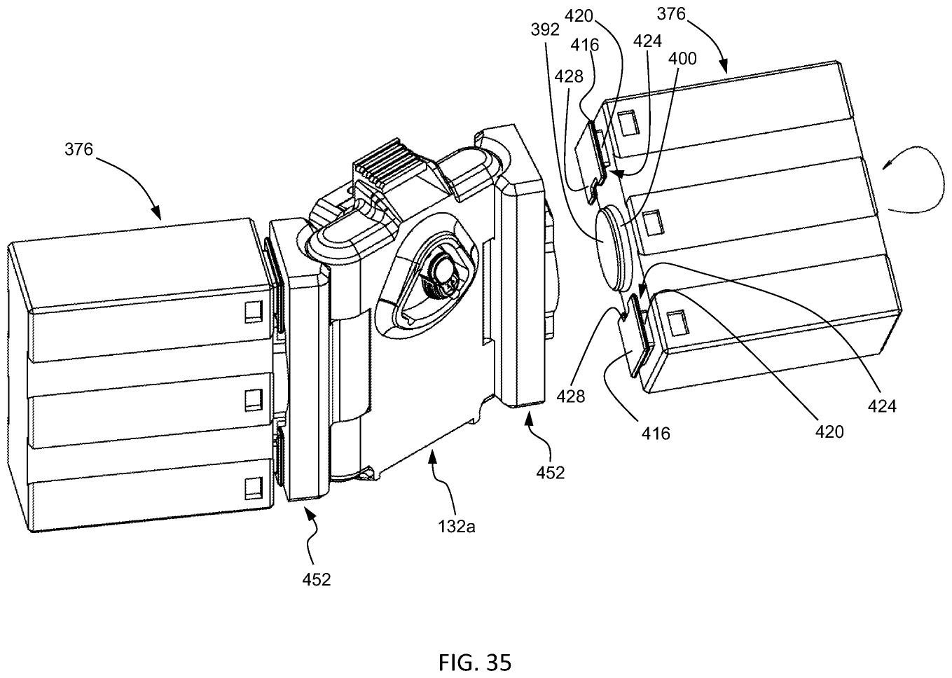

Tabs 416 are disposed at opposing ends of the interface surface 388 and are supported on respective posts or bosses 420 (see FIG. 35) to define a peripheral retention channel 424 between the tabs and the interface surface 388. The tabs 416 include bayonet or twist type retention elements 428 for attachment of the battery pack 376 to the adapter surface 384 via twisting movement of the battery pack 376 relative to the stub adapter second interface surface 384.

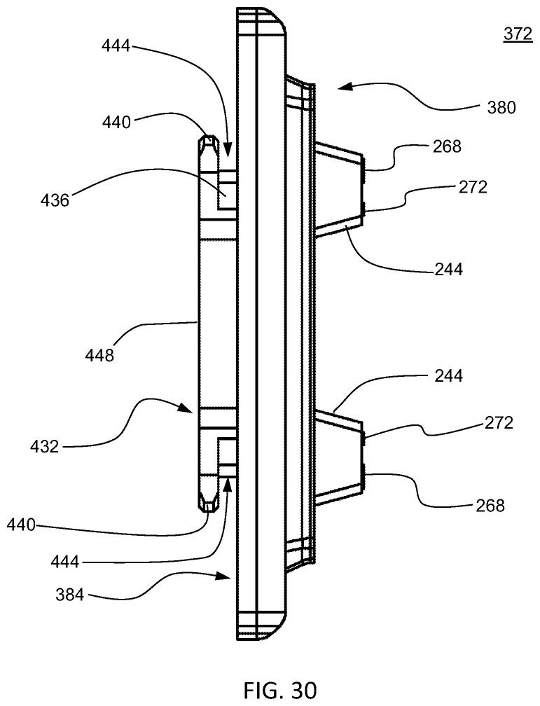

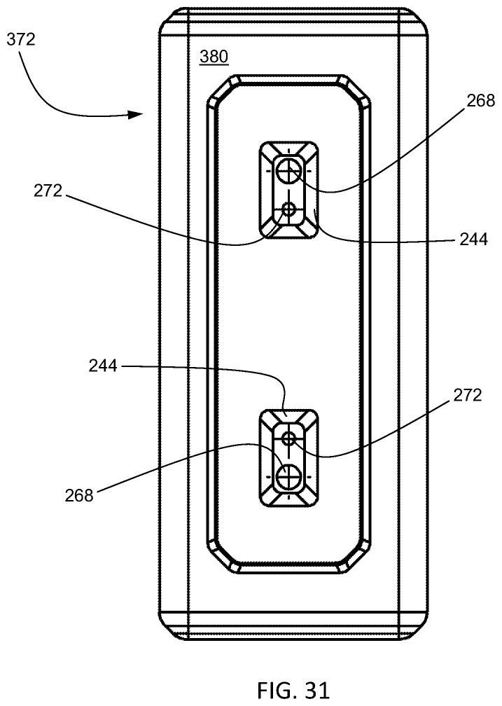

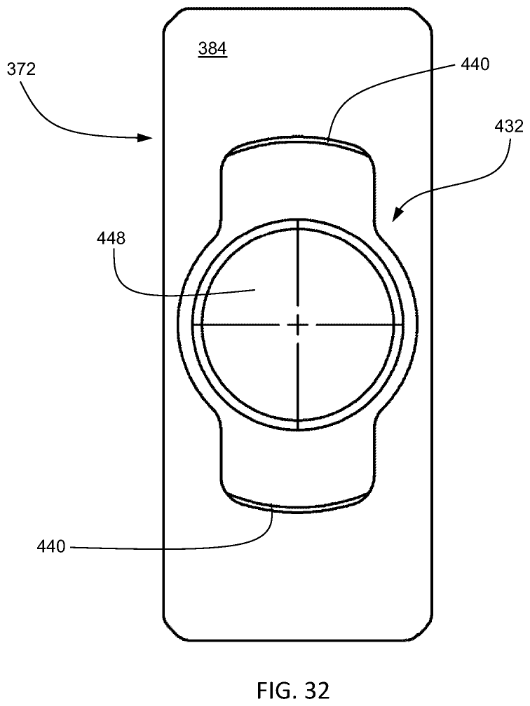

Referring now to FIGS. 30-32, and with continued reference to FIGS. 1-29, the adapter first interface surface 380 includes a pair of connector lugs 244 as described above each having a magnet fastener element 268 and an electrical connector element 272. The adapter 372 is physically attached and detached from the side surfaces 148 of the battery pack center base module 132 via the magnetic fastener elements as described above.

The second adapter interface surface 384 includes a bayonet type mount 432 including a center post 436 and opposing ears 440. The ears 440 extend from the post 436 to define a retention groove 444 between each of the ears 440 and the surface 384. A center terminal 448 on the bayonet mount assembly 432 is aligned with the center terminal 392, which includes terminals that are electrically coupled to the terminals 272 on the first interface surface 380 to electrically couple the battery pack 376 to the battery pack center base module 132.

In operation, to attach the battery pack 376 to the adapter second interface surface 384, the battery pack 376 is positioned so that the center terminals 392 and 448 are aligned and the twist retention elements 428 on the STUB battery pack 376 are angularly offset with respect to the bayonet ears 440 on the adapter second interface 384. The STUB battery pack 376 is then rotated to cause the twist retention elements 428 to engage the retention grooves 444. To remove the battery pack 376 from the adapter second interface surface 384, the process is reversed.

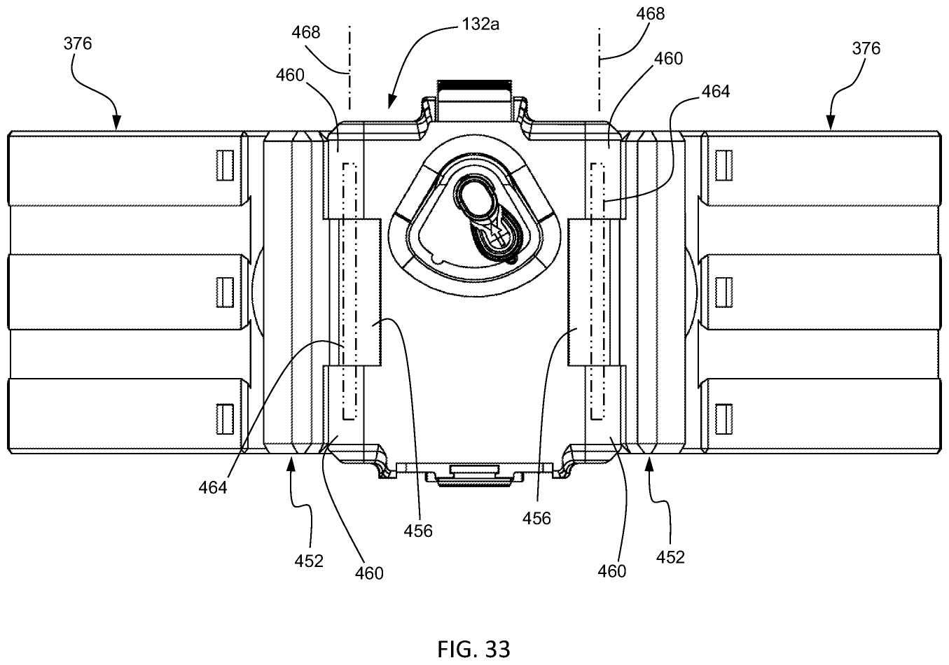

Referring now to FIGS. 33-35 and with continued reference to FIGS. 1-32, there is shown a second embodiment battery pack center base module 132a, which is as described above by way of reference to the battery pack center base module 132, except that the left and right side surfaces 148 have been replaced with hinged STUB attachment interface assemblies 452.

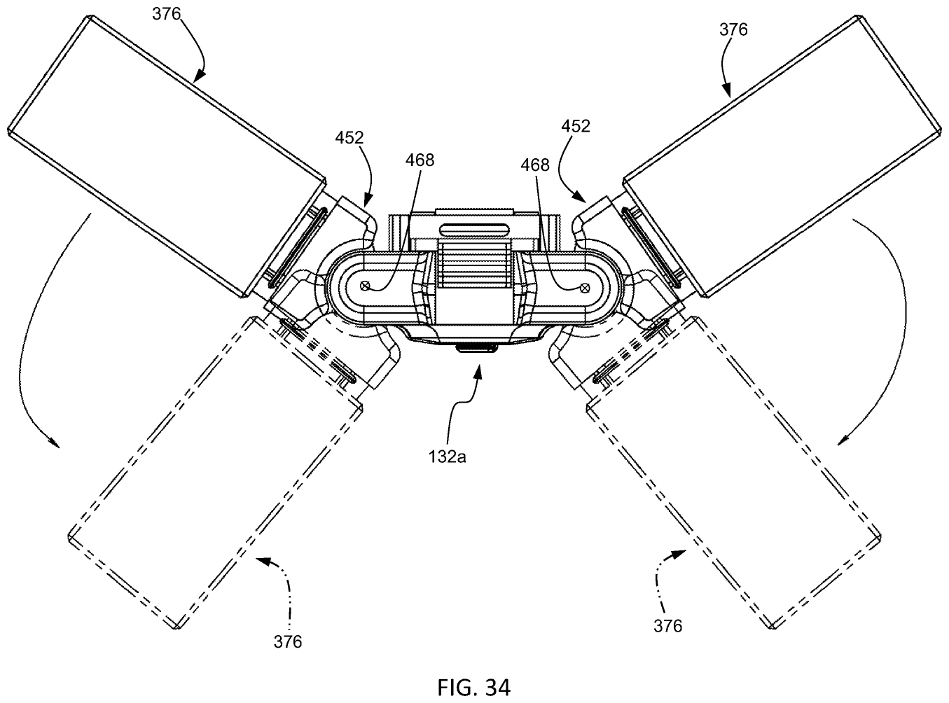

In certain embodiments, the hinge interface assemblies 452 each include a hinge knuckle 456 intermeshed between two hinge knuckles 460 on a main body 136a of the battery pack center base module 132a and rotatably attached with a hinge pin 464, each defining a pivot axis 468. As best seen in FIG. 34, the hinged connection allow the battery packs 376 to be pivoted about the axis 468 toward the helmet during normal use (as shown in solid lines in FIG. 34), and to be pivoted away from the helmet (as shown in broken lines in FIG. 34) when it is desired to remove or replace the battery pack 376.

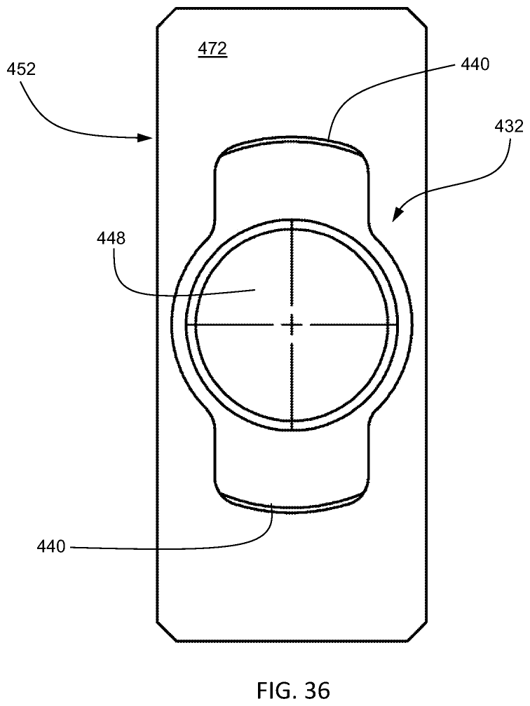

Referring now to FIG. 36, and with continued reference to FIGS. 1-35, there is shown an interface surface 472 of the hinge assembly 452 which is configured to detachably engage with the interface surface 388 (see FIG. 29) of the STUB battery pack 376. The interface surface 472 includes a bayonet type mount 432 including a center post 436 (see FIG. 30) and opposing ears 440. The ears 440 extend from the post 436 to define a retention groove 444 (see FIG. 30) between each of the ears 440 and the surface 472. A center terminal 448 on the bayonet mount assembly 432 is aligned with the center terminal 392, which includes terminals that engage the terminals 404 to electrically couple the battery pack 376 to the battery pack center base module 132a.

In operation, to attach the battery pack 376 to STUB hinge interface 472, the battery pack 376 is positioned so that the center terminals 392 and 448 are aligned and the twist retention elements 428 on the STUB battery pack 376 are angularly offset with respect to the bayonet ears 440 on the hinge interface 472. The STUB battery pack 376 is then rotated to cause the twist retention elements 428 to engage the retention groove 444. To remove the battery pack 376 from the hinge interface 472, the hinged adapter 452 is pivoted so that the interface surface 472 faces away from the helmet and battery pack 376 is twisted until the twist retention elements 428 disengage from the retention grooves 444.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A battery pack system for a helmet mount assembly, comprising:
a center base module configured for electrical and physical attachment to a helmet mount assembly;
first and second battery packs for removable attachment to the center base module;
each of the first and second battery packs having a pair of protruding attachment lugs, each of the attachment lugs having first magnetic fastener element and a first electrical connector element;
the center base module having a first side surface configured for detachably securing the first battery pack;
the center base module having a second side surface opposite the first side surface configured for detachably securing the second battery pack;
each of the first and second side surfaces comprising a pair of lug receptacles for receiving a respective one of the pairs of protruding attachment lugs;
each lug receptacle having a second magnetic fastener element for physically coupling to a respective one of the first magnetic fastener elements; and
each lug receptacle having a second electrical connector element for electrically coupling to a respective one of the first electrical connector elements.

2. The battery pack system of claim 1, further comprising an adapter interchangeably attachable to the helmet mount assembly in place of the center base module and configured to releasably attach a third battery pack.

3. The battery pack system of claim 1, wherein the center base module comprises a modular processing system removably received within a main body of the center base module.

4. The battery pack system of claim 1, wherein the center base module comprises a switch configured to selectively couple a selected one of the first and second battery packs, wherein each of the first and second battery packs is replaceable independently of the other.

5. The battery pack system of claim 1, wherein the attachment lugs are frusto-pyramidical in shape.

6. The battery pack system of claim 1, further comprising:
first and second adapters;
the first adapter having a first interface surface configured for removable attachment to the first side surface of the center base module and a second interface surface configured for removable attachment to the first battery pack; and
the second adapter having a third interface surface configured for removable attachment to the second side surface of the center base module and a fourth interface surface configured for removable attachment to the second battery pack.

7. The battery pack system of claim 6, wherein the first and second battery packs are STUB battery packs.

8. A battery pack system for a helmet mount assembly, comprising:
a center base module configured for electrical and physical attachment to a helmet mount assembly;
first and second battery packs for removable attachment to the center base module;
a first adapter hingedly attached to a first side of the center base module and having a first interface surface configured for removable attachment to the first battery pack; and
a second adapter hingedly attached to a second side of the center base module and having a second interface surface configured for removable attachment to the second battery pack.

9. The battery pack system of claim 8, wherein the first and second adapters are pivotable between a deployed position wherein the first and second battery packs are pivoted toward the helmet and a non-deployed position wherein the first and second battery packs are pivoted away the helmet to facilitate attachment and removal of the first and second battery packs.

10. The battery pack system of claim 8, wherein the first and second battery packs are STUB battery packs.
